(19) United States
(12) Patent Application Publication
(10) Pub. No.: US 2018/0160017 A1
(43) Pub. Date: Jun. 7, 2018

(54) CAMERA MODULE

(71) Applicant: SAMSUNG ELECTRO-MECHANICS CO., LTD., Suwon-si (KR)

(72) Inventors: Chuel Jin PARK, Suwon-si (KR); Jae Sun LEE, Suwon-si (KR); Ik Jin JANG, Suwon-si (KR); Dong Ryul KIM, Suwon-si (KR); Sang Hyun JI, Suwon-si (KR)

(73) Assignee: SAMSUNG ELECTRO-MECHANICS CO., LTD., Suwon-si (KR)

(21) Appl. No.: 15/828,564

(22) Filed: Dec. 1, 2017

(30) Foreign Application Priority Data
Dec. 1, 2016 (KR) 10-2016-0162741

(51) Int. Cl. H04N 5/225; G02B 13/06; G02B 7/02; G03B 17/56

(52) U.S. Cl. CPC H04N 5/2253; G02B 13/06; G02B 7/021; H04N 5/2252; G03B 17/565; H04N 5/2254; G03B 17/561

(57) ABSTRACT

A camera module includes lens modules; and image sensors corresponding to lens modules, wherein f-numbers of the lens modules corresponding to numerical values indicating amounts of light passing through the lens modules, respectively, are different from each other, and an image sensor corresponding to a lens module having a relatively greater f-number is a color (RGB) sensor and an image sensor corresponding to a lens module having a relatively smaller f-number is a black and white (BW) sensor.

### CROSS-REFERENCE TO RELATED APPLICATION(S)

This application claims benefit under 35 USC § 119(a) of Korean Patent Application No. 10-2016-01 62741 filed on Dec. 1, 2016 in the Korean Intellectual Property Office, the entire disclosure of which is incorporated herein by reference for all purposes.

### BACKGROUND

### 1. Field

The following description relates to a camera module.

### 2. Description of Related Art

Camera modules are commonly provided in mobile communications terminals, such as tablet personal computers (PC), laptop computers, and the like, as well as in smartphones.

In addition, recently, a dual camera module, in which two lens modules are mounted, has been disclosed, and such a dual camera module has been designed in only a form in which the same two camera modules are simply disposed in parallel.

However, in conventional camera modules, when an image is captured in an environment in which an amount of light is low, the captured image may be too dark.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing including a first lens module and a second lens module, a first image sensor and a second image sensor configured to convert light passing through the first lens module and the second lens module into an electrical signal, wherein the first image sensor is a color (RGB) sensor, and the second image sensor is a black and white (BW) sensor, and an f-number of the first lens module and an f-number of the second lens module corresponding to numerical values of amounts of light passing through the first lens module and the second lens module, are different from each other.

The f-number of the first lens module may be greater than the f-number of the second lens module.

A size of a pixel of the second image sensor may be smaller than a size of a pixel of the first image sensor.

A size of the second image sensor may be smaller than a size of the first image sensor.

The first image sensor and the second image sensor may be disposed on one printed circuit board.

A controller configured to synthesize a first image from the first image sensor and a second image from the second image sensor may be disposed on the printed circuit board.

The controller may be configured to extract color information and depth data from the first image, the controller may be configured to extract brightness data from the second image, and the controller may be configured to synthesize the extracted color information and depth data and the extracted brightness data.

The controller may be configured to extract color information and depth data from the first image, the controller may be configured to extract image regions and brightness data from the second image, and the controller may be configured to synthesize the extracted color information and depth data and the extracted image regions and brightness data.

The controller may be disposed between the first image sensor and the second image sensor.

The first lens module and the second lens module may have different fields of view.

A shortest distance between an optical axis of the first lens module and an optical axis of the second lens module may be smaller than a width of the housing.

In another general aspect, a camera module includes lens modules independently configured to capture an image of a subject a housing including the lens modules, and an image sensor module coupled to the housing and configured to convert light passing through the lens modules into an electrical signal, wherein the image sensor module includes image sensors corresponding to the lens modules and a printed circuit board on which the image sensors are disposed, f-numbers of the lens modules corresponding to numerical values of amounts of light passing through the lens modules are different from each other, and an image sensor corresponding to a lens module having a larger f-number in comparison with another of the lens modules is a color (RGB) sensor, and an image sensor corresponding to a lens module having a smaller f-number in comparison with another of the lens modules is a black and white (BW) sensor.

A controller configured to synthesize images from the image sensors may be disposed on the printed circuit board.

An actuator may be configured to independently move each of the lens modules in an optical axis direction.

The controller may be configured to extract color information and depth data from the first image, the controller may be configured to extract brightness data from the second image, and the controller may be configured to synthesize the extracted color information and depth data and the extracted image regions and brightness data into a single image.

The controller may be configured to extract color information and depth data from the first image, the controller may be configured to extract image regions and brightness data from the second image, and the controller may be configured to synthesize the extracted color information and depth data and the extracted image regions and brightness data into a single image.

Other features and aspects will be apparent from the following detailed description, the drawings, and the claims.

### BRIEF DESCRIPTION OF DRAWINGS

FIG. 1 is a perspective view of a camera module according to an embodiment.

FIG. 2 is an exploded perspective view of a camera module according to an embodiment.

FIG. 3 is an exploded perspective view of a camera module according to an embodiment.

FIG. 4 is a plan view of a distance between optical centers of two lens modules and a width of a housing in the camera module according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Terms with respect to directions will be defined. An optical axis direction refers to a vertical direction in relation to a first lens module 210 or a second lens module 230.

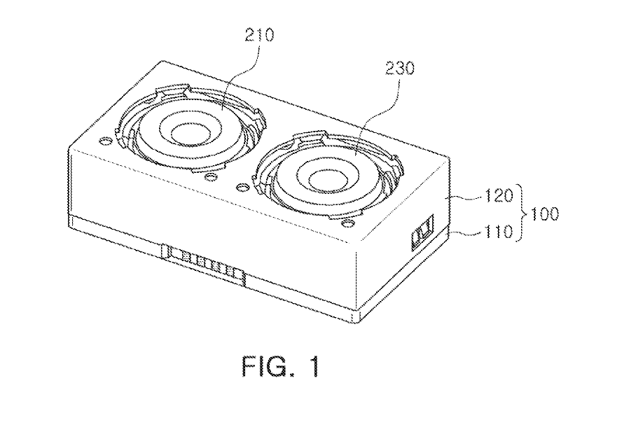

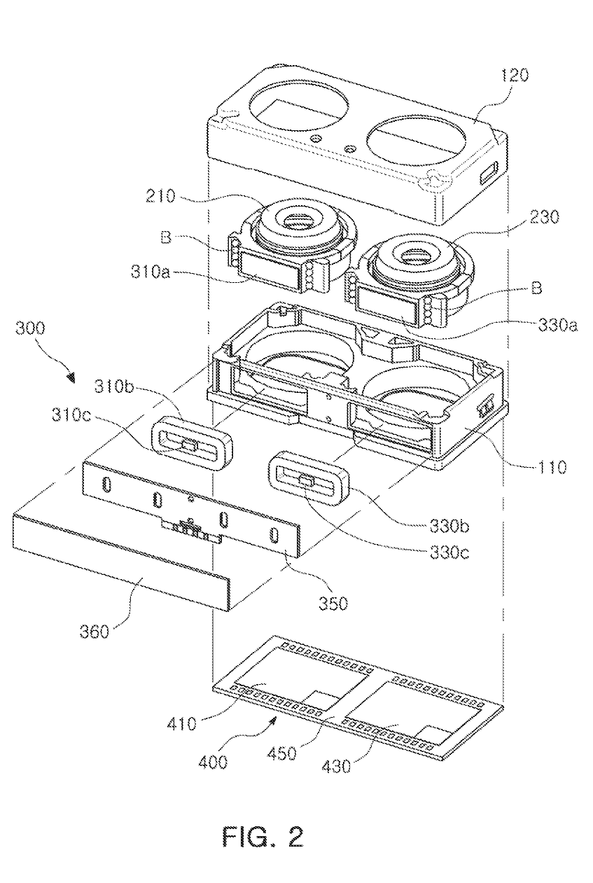

FIG. 1 is a perspective view of a camera module according to an embodiment in the present disclosure, and FIG. 2 is an exploded perspective view of the camera module according to an embodiment.

Referring to FIGS. 1 and 2, the camera module according to an embodiment includes lens modules 210 and 230 that are independently movable, a housing 100 accommodating the lens modules 210 and 230 therein, and an actuator 300 moving each of the lens modules 210 and 230 in the optical axis direction.

For example, the camera module according to an embodiment includes a first lens module 210, a second lens module 230, a housing 100 accommodating the first and second lens modules 210 and 230 therein, and an actuator 300 moving the first and second lens modules 210 and 230 in the optical axis direction, and further includes an image sensor module 400 converting light incident thereto through the first and second lens modules 210 and 230 into electrical signals.

The first lens module 210 and the second lens module 230 include lens barrels, respectively, and the respective lens barrels have a cylindrical shape so that lenses capturing an image of a subject may be accommodated therein. The lenses may be disposed on an optical axis.

The first lens module 210 and the second lens module 230 are accommodated in the housing 100 to be movable in the optical axis direction. In addition, the first lens module 210 and the second lens module 230 are independently movable.

The housing 100 accommodates both of the first lens module 210 and the second lens module 230 therein, and two movement spaces may be formed in the housing 100 so that the first lens module 210 and the second lens module 230 are independently movable.

The housing 100 includes a base 110 and a case 120 coupled to the base 110.

The base 110 is provided with two optical path windows. Therefore, light passing through the first lens module 210 and the second lens module 230 through the two optical path windows is received by image sensors 410 and 430.

The case 120 may be coupled to the base 110, and may serve to protect internal components of the camera module.

The image sensor module 400 is a device converting the light passing through the first lens module 210 and the second lens module 230 into electrical signals, and may be attached to the housing 100.

As an example, the image sensor module 400 includes a printed circuit board 450 attached to the base 110, and a first image sensor 410 and a second image sensor 430 connected to the printed circuit board 450.

The first image sensor 410 and the second image sensor 430 may be mounted on one printed circuit board 450.

In addition, the image sensor module 400 may further include an infrared filter.

The infrared filter serves to cut off light in an infrared region in the light incident thereto through the first and second lens modules 210 and 230.

The first image sensor 410 and the second image sensor 430 convert light incident thereto through the first lens module 210 and the second lens module 230, respectively, into electrical signals.

As an example, the first image sensor 410 and the second image sensor 430 may be charge coupled devices (CCDs) or complementary metal oxide semiconductors (CMOSs).

The actuator 300 is a device moving the first lens module 210 and the second lens module 230 in the optical axis direction.

The actuator 300 is disposed between the first and second lens modules 210 and 230 and the housing 100, and moves the first lens module 210 and the second lens module 230 in the optical axis direction to focus the first lens module 210 and the second lens module 230.

The actuator 300 includes magnets 310a and 330a and coils 310b and 330b to independently move the first lens module 210 and the second lens module 230.

When power is applied to the coils 310b and 330b, the first lens module 210 and the second lens module 230 may be moved in the optical axis direction by electromagnetic interaction between the magnets 310a and 330a and the coils 310b and 330b.

A first magnet 310a is attached to one side surface of the first lens module 210, and a second magnet 330a is attached to one side surface of the second lens module 230.

In addition, a first coil 310b is disposed to face the first magnet 310a in a direction perpendicular to the optical axis direction, and a second coil 330b is disposed to face the second magnet 330a in a direction perpendicular to the optical axis direction.

A closed loop control manner of sensing and feeding back positions of the lens modules 210 and 230 may be used.

Therefore, position sensors 310c and 330c may be required in order to perform a closed loop control. The position sensors 310c and 330c may be hall sensors.

The position sensors 310c and 330c may be disposed inside or outside the first and second coils 310b and 330b, respectively.

As an example, the position sensors 310c and 330c are provided on a substrate 350 to be disposed inside the first and second coils 310b and 330b, respectively, and are surrounded by the first and second coils 310b and 330b, respectively. Therefore, separate spaces in which the position sensors 310c and 330c are mounted are not required, and the camera module is thus miniaturized.

Position sensors 310c and 330c are provided to sense positions of the first and second lens modules 210 and 230, respectively. As an example, position sensors 310c and 330c includes a first position sensor 310c sensing a position of the first lens module 210 and a second position sensor 330c sensing a position of the second lens module 230.

The first position sensor 310c and the second position sensor 330c sense the position of the first lens module 210 to which the first magnet 310a is attached and the position of the second lens module 230 to which the second magnet 330a is attached through changes in magnetic flux densities of the first magnet 310a and the second magnet 330a, respectively.

The substrate 350 may be attached to the housing 100, and the first coil 310b and the second coil 330b may be fixed to the housing 100 through the substrate 350.

As an example, the substrate 350 is attached to a side surface of the housing 100 having a larger length among side surfaces of the housing 100, and the first coil 310b and the second coil 330b are provided on one surface of the substrate 350.

Meanwhile, ball members B may be disposed between the first and second lens modules 210 and 230 and the housing 100 to guide movement of the first and second lens modules 210 and 230.

The ball members B may be disposed in the optical axis direction, and moved in a rolling motion when the first and second lens modules 210 and 230 are moved.

A yoke 360 configured to generate attractive force in a direction perpendicular to the optical axis direction with respect to the first magnet 310a and the second magnet 330a may be provided on the other surface of the substrate 350.

Therefore, the ball members B are maintained in a state in which they are in contact with the first lens module 210, the second lens module 230, and the housing 100 by the attractive force between the first and second magnets 310a and 330a and the yoke 360.

The yoke 360 may be one yoke disposed to face the first magnet 310a and the second magnet 330a in a direction perpendicular to the optical axis direction. However, the yoke 360 is not limited thereto. That is, two yokes may also be disposed to correspond to the first magnet 310a and the second magnet 330a, respectively.

Meanwhile, the first lens module 210 and the second lens module 230 may have the same field of view.

As an example, the first lens module 210 and the second lens module 230 have a field of view of about 76°.

In addition, sizes of pixels of the first image sensor 410 and the second image sensor 430 may be the same as each other.

Further, any one of the first image sensor 410 and the second image sensor 430 may be a color (RGB) sensor, and the other of the first image sensor 410 and the second image sensor 430 may be a black and white (BW) sensor.

As an example, the first image sensor 410 is a color (RGB) sensor, and the second image sensor 430 is a black and white (BW) sensor.

In this example, lenses of the first lens module 210 corresponding to the first image sensor 410, which is the color (RGB) sensor, have a relatively greater F number (f-number: a numerical value indicating a brightness level of the lens or a numerical number indicating an amount of light passing through the lens). When an image sensor “corresponds to” a lens module, this can generally mean that the image sensor is configured to receive light from the lens module.

In addition, lenses of the second lens module 230 corresponding to the second image sensor 430, the black and white (BW) sensor, may have a relatively smaller f-number.

When the f-number is relatively greater, a focal depth becomes deep, but an amount of light passing through the lens at the same time may be reduced, and a dark image may thus be captured.

To the contrary, when the f-number is relatively smaller, a focal depth may become shallow, but an amount of light passing through the lens for the same time may become large and a bright image may thus be captured.

Therefore, in an embodiment, an image that has a deep focal depth and is bright is created by extracting brightness data from an image captured through the lens module having the relatively smaller f-number, extracting depth data from an image captured through the lens module having the relatively greater f-number, and synthesizing the brightness data and the depth data.

As an example, since the f-number of the first lens module 210 is relatively greater, an image having a deep focal depth is created through the first lens module 210 and the first image sensor 410, and since the f-number of the second lens module 230 is relatively smaller, a bright image is created through the second lens module 230 and the second image sensor 430.

Therefore, these two images are synthesized, such that an image that has deep focal depth and is bright is created.

Therefore, an image of a subject is clearly captured even in a low illuminance environment in which an amount of light is low.

A controller (not illustrated) processing images formed of digital signals in order to synthesize the images may be provided on the printed circuit board 450.

The controller (not illustrated) may be disposed in a space between the first image sensor 410 and the second image sensor 430.

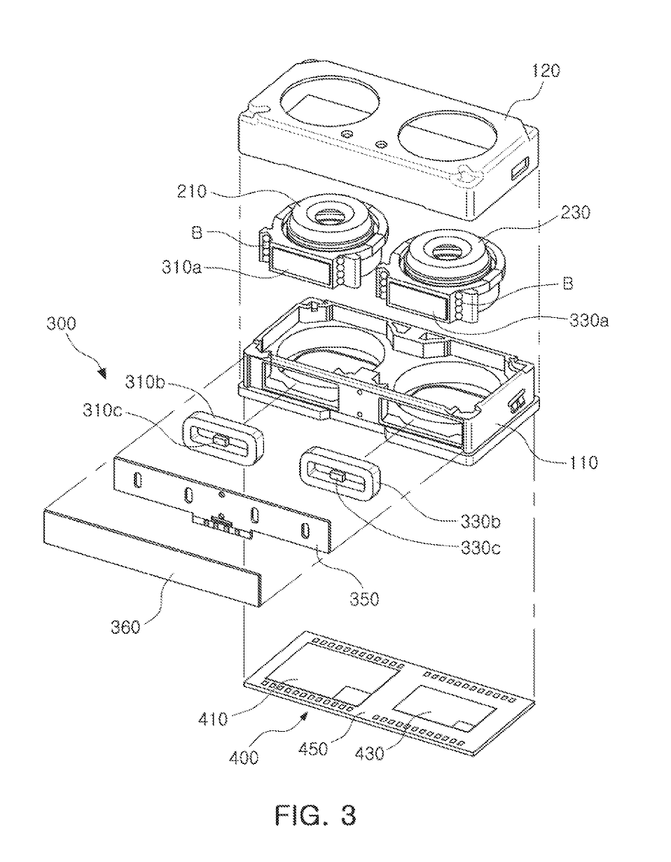

FIG. 3 is an exploded perspective view of a camera module according to an embodiment.

The camera module according to an embodiment of FIG. 3 may be the same as the camera module according to embodiments illustrated in FIGS. 1 and 2 except for a size of a second image sensor 430.

Referring to FIG. 3, the second image sensor 430 is formed at a size smaller than that of the first image sensor 410.

Here, the second image sensor 430 has pixels of which the number is same as that of pixels of the first image sensor 410, but sizes of the pixels of the second image sensor 430 are smaller than those of the pixels of the first image sensor 410.

As in embodiments of FIGS. 1 and 2, the first image sensor 410 may be a color (RGB) sensor, and the second image sensor 430 may be a black and white (BW) sensor.

In addition, the first lens module 210 corresponding to the first image sensor 410 has a relatively greater f-number, and the second lens module 230 corresponding to the second image sensor 430 has a relatively smaller f-number.

Therefore, even though an image is captured at the same shutter speed, an amount of light received by the second image sensor 430 may be greater than that of light received by the first image sensor 410.

Therefore, the second image sensor 430 has pixels, of which the number is same as that of pixels of the first image sensor 410, but the sizes of the pixels of the second image sensor 430 is reduced.

When the sizes of the pixels are reduced, amounts of light received by the respective pixels are reduced. However, since a total amount of light transferred to the second image sensor 430 is great, even though the sizes of the pixels of the second image sensor 430 are reduced, a sufficiently bright image is created.

Through the configuration as described above, in an embodiment in FIG. 3, an image that has a deep focal depth and is bright is created, and an entire size of the camera module is reduced.

Meanwhile, a example in which fields of view of the first lens module 210 and the second lens module 230 are the same as each other is described in the embodiments of FIGS. 1 through 3, but the fields of view of the first lens module 210 and the second lens module 230 are not limited thereto, but may also be different from each other.

That is, any one of the first lens module 210 and the second lens module 230 may have a relatively wider field of view (a wide angle lens), and the other thereof may have a relatively narrower field of view (a telephoto lens).

As an example, the first lens module 210 may be formed of a wide angle lens having a wider field of view, and the second lens module 230 may be formed of a telephoto lens having a narrow field of view.

Therefore, the first lens module 210 may be the wide angle lens having the wider field of view and have a relatively greater f-number, and the second lens module 230 may be the telephoto lens having the narrow field of view and have a relatively smaller f-number.

Through the configuration as described above, when an image for a region having a narrow field of view is created, the first image sensor 410 may extract color information and depth data of the image, the second image sensor 430 may extract image regions and brightness data of the image, and the extracted color information and depth data and the extracted image regions and brightness data may be synthesized.

Therefore, an image that has a deep focal depth and is bright is created with respect to the region having the narrow field of view.

In addition, when an image for a region having a wide field of view is created, the first image sensor 410 may extract color information and depth data of the image, the second image sensor 430 may extract brightness data of the image, and the extracted color information and depth data and the extracted brightness data may be synthesized.

Therefore, an image that has a deep focal depth and is bright is created with respect to the region having the wide field of view.

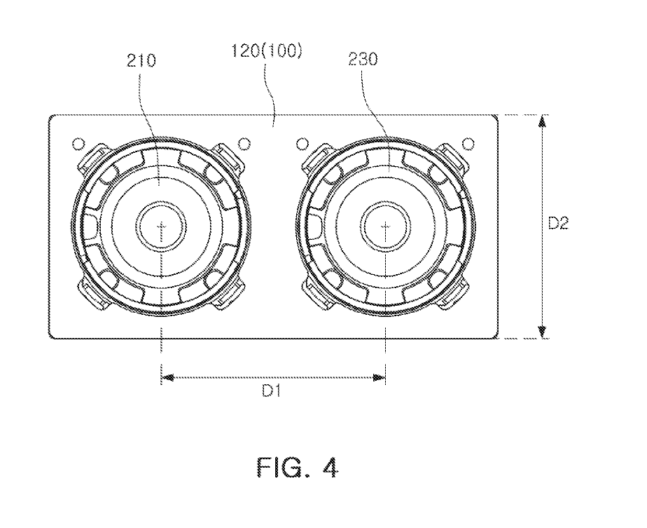

FIG. 4 is a plan view showing a distance between optical centers of two lens modules and a width of a housing in the camera module according to an embodiment.

Referring to FIG. 4, a distance D1 between an optical center of the first lens module 210 and an optical center of the second lens module 230 is smaller than a width D2 of the housing 100.

In addition, the shortest distance D1 between an optical axis of the first lens module 210 and an optical axis of the second lens module 230 is smaller than the width D2 of the housing 100.

Here, the optical centers refer to points at which light meets the optical axes of the first and second lens modules 210 and 230, and the width refers to a length of a short side of sides of the housing 100 in the plan view of FIG. 6.

In order to generate an image having a high level of resolution or a bright image using two images captured by two lens modules, a distance between optical centers of the two lens modules needs to be designed to be small.

As an example, when the distance between the optical centers of the two lens modules is designed to be large, two images captured for one subject are different from each other, such that it may be difficult to generate the image having the high level of resolution or the bright image.

Therefore, in the camera module according to an embodiment, the distance D1 between the optical center of the first lens module 210 and the optical center of the second lens module 230 is designed to be smaller than the width D2 of the housing 100 to generate various images using two images for one subject.

As set forth above, according to the exemplary embodiments in the present disclosure, an image that is bright and has a deep focal depth is created even in an environment in which an amount of light is low. In addition, the camera module has a reduced size in spite of using the plurality of lens modules.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a first lens module and a second lens module disposed in the housing;
a first image sensor and a second image sensor configured to convert light passing through the first lens module and the second lens module into an electrical signal,
wherein the first image sensor comprises a color (RGB) sensor, and the second image sensor comprises a black and white (BW) sensor, and
an f-number of the first lens module and an f-number of the second lens module corresponding to numerical values of amounts of light passing through the first lens module and the second lens module, are different from each other.

2. The camera module of claim 1, wherein the f-number of the first lens module is greater than the f-number of the second lens module.

3. The camera module of claim 1, wherein a size of a pixel of the second image sensor is smaller than a size of a pixel of the first image sensor.

4. The camera module of claim 3, wherein a size of the second image sensor is smaller than a size of the first image sensor.

5. The camera module of claim 1, wherein the first image sensor and the second image sensor are disposed on one printed circuit board.

6. The camera module of claim 5, wherein a controller configured to synthesize a first image from the first image sensor and a second image from the second image sensor is disposed on the printed circuit board.

7. The camera module of claim 6, wherein the controller is configured to extract color information and depth data from the first image, brightness data from the second image, and synthesize the extracted color information and depth data and the extracted brightness data.

8. The camera module of claim 6, wherein the controller is configured to extract color information and depth data from the first image, image regions and brightness data from the second image, and synthesize the extracted color information and depth data and the extracted image regions and brightness data.

9. The camera module of claim 6, wherein the controller is disposed between the first image sensor and the second image sensor.

10. The camera module of claim 1, wherein the first lens module and the second lens module have different fields of view.

11. The camera module of claim 1, wherein a shortest distance between an optical axis of the first lens module and an optical axis of the second lens module is smaller than a width of the housing.

12. A camera module comprising:
a housing;
lens modules disposed in the housing and configured to independently capture an image of a subject; and
an image sensor module coupled to the housing and configured to convert light passing through the lens modules into an electrical signal,
wherein the image sensor module comprises image sensors corresponding to the lens modules and a printed circuit board on which the image sensors are disposed,
wherein f-numbers of the lens modules corresponding to numerical values of amounts of light passing through the lens modules are different from each other, and
an image sensor corresponding to a lens module, among the lens modules, having a larger f-number in comparison with another lens module among the lens modules, is a color (RGB) sensor, and an image sensor corresponding to a lens module having a smaller f-number in comparison with another lens module among the lens modules, is a black and white (BW) sensor.

13. The camera module of claim 12, wherein a controller configured to synthesize images from the image sensors is disposed on the printed circuit board.

14. The camera module of claim 12, wherein an actuator is configured to independently move each of the lens modules in an optical axis direction.

15. The camera module of claim 12, wherein the controller is configured to extract color information and depth data from the first image, extract brightness data from the second image, and synthesize the extracted color information and depth data and the extracted image regions and brightness data into a single image.

16. The camera module of claim 12, wherein the controller is configured to extract color information and depth data from the first image, extract image regions and brightness data from the second image, and synthesize the extracted color information and depth data and the extracted image regions and brightness data into a single image.
